(19) United States
(12) Patent Application Publication
(10) Pub. No.: US 2010/0293952 A1
(43) Pub. Date: Nov. 25, 2010

(54) Resonating Swirler

(75) Inventors: Praveen Babulal Jain, Bangalore Karnataka (IN); Shiva Srinivasan, Greer, SC (US); Dheeraj Sharma, Bangalore Karnataka (IN)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schnectady, NY (US)

(21) Appl. No.: 12/469,858

(22) Filed: May 21, 2009

(51) Int. Cl. F02C 7/24

(52) U.S. Cl. 60/725

(57) ABSTRACT

The present application provides a swirler for a turbine combustor. The swirler may include an outer wall, a passage defined by the outer wall, and an end wall. The end wall may include a number of apertures therethrough.

### TECHNICAL FIELD

The present application relates generally to gas turbine engines and more particularly relates to a swirler for a combustor that absorbs high frequency pressure waves as a resonator.

### BACKGROUND OF THE INVENTION

Current designs of Dry Low NOₓ (DLN) gas turbines generally operate with a lean fuel air mixture. The lean fuel air mixture includes an amount of fuel premixed with a large amount of excess air that is burned in a combustion chamber. Although such a lean mixture reduces the amount of NOₓ emissions, low and high frequency combustion instabilities may result. The high frequency combustion instabilities may be referred to as screech. These instabilities may be caused by burning rate fluctuations coupled with fuel-air flow fluctuations and combustor acoustics. This coupling may result in a very high amplitude of low frequency combustion instability and screech inside the combustor. Even a small amplitude of screech inside the combustor may quickly reduce the life of the components of the combustor.

To reduce the amplitude of such screech instabilities, carefully located damping or resonating devices may be used about the combustor. These known resonating devices, however, have not been completely effective in completely absorbing the high frequencies.

There thus is a desire for an improved resonating device, particularly for the combustor of a Dry Low NO turbine. Such a resonating device preferably should absorb high frequency screech while promoting overall turbine efficiency and performance.

### SUMMARY OF THE INVENTION

The present application thus provides a swirler for a turbine combustor. The swirler may include an outer wall, a passage defined by the outer wall, and an end wall. The end wall may include a number of apertures therethrough.

The present application further provides for a swirler for a turbine combustor. The swirler may include an outer wall, an inner wall, a cavity defined by the outer wall and the inner wall, and an end wall. The outer wail may include a number of outer wall apertures therethrough.

The present application further provides for an outer swirler for a secondary nozzle of a turbine combustor. The swirler may include an outer wall, a nozzle wall, a passage defined by the outer wall and the nozzle wall, and an end wall. The end wall may include a number of apertures therethrough such that the swirler may include a resonance frequency therethrough.

These and other features of the present application will become apparent to one of ordinary skill in the art upon review of the following detailed description when taken conjunction with the several drawings and the appended claims.

### BRIEF DESCRIPTION OF THE DRAWINGS

FIG. 1 is a schematic view of a as turbine engine.

FIG. 2 is a partial cross-sectional view of a known Dry Low NOₓ combustor.

FIG. 3 is a side cross-sectional view of an outer swirler of the Dry Low NOₓ combustor of FIG. 2.

FIG. 4 is a perspective view of the end wall of the outer swirler of FIG. 3.

FIG. 5 is a side cross-sectional view of an outer swirler as is described herein.

FIG. 6 is a perspective view of the end wall of the outer swirler of FIG. 5.

FIG. 7 is a side cross-sectional view showing the back end plate of the outer swirler of FIG. 5.

FIG. 8 is a side cross-sectional view of an alternative embodiment of an outer swirler as is described herein.

### DETAILED DESCRIPTION

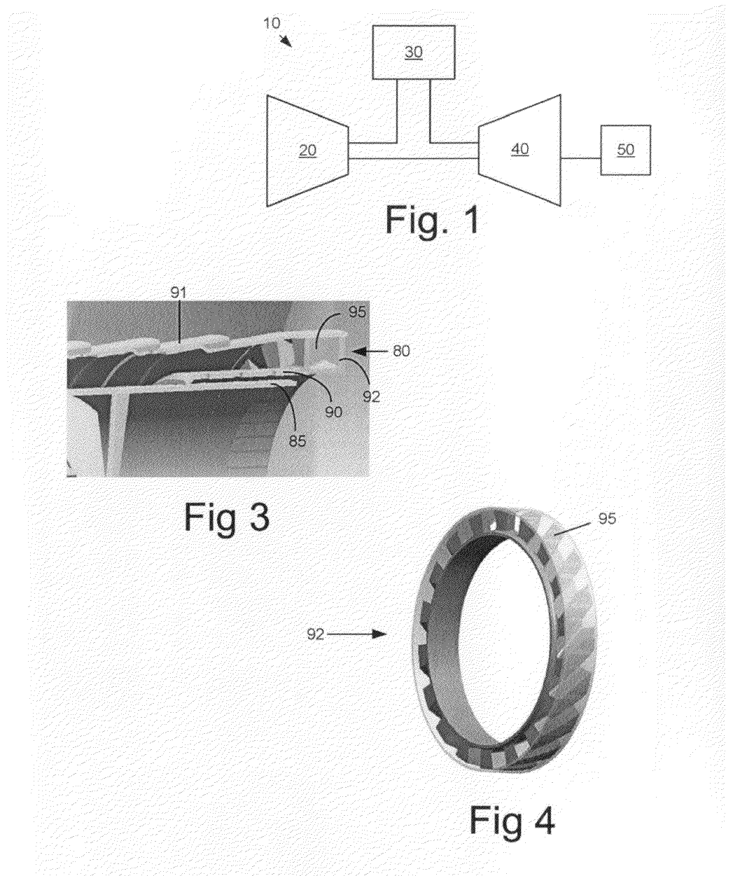

Referring now to the drawings, in which like numbers refer to like elements throughout the several views FIG. 1 shows a schematic view of a gas turbine engine 10. As is known, the gas turbine engine 10 may include a compressor 20 to compress an incoming flow of air. The compressor 20 delivers the compressed flow of air to a combustor 30. The combustor 30 mixes the compressed flow of air with the compressed flow of fuel and ignites the mixture. (Although only a single combustor 30 is shown, the gas turbine engine 10 may include any number of combustors 30.) The hot combustion gases are in turn delivered to a turbine 40. The hot combustion gases drive the turbine 40 so as to produce mechanical work. The mechanical work produced in the turbine 40 drives the compressor 20 and an external load 50 such as an electrical generator and the like. The gas turbine engine 10 may use natural gas, various types of syngas, and other types of fuels. The gas turbine engine 10 may have other configurations and may use other types of components. Multiple gas turbine engines 10, other types of turbines, and other type of power generation equipment may be used herein together.

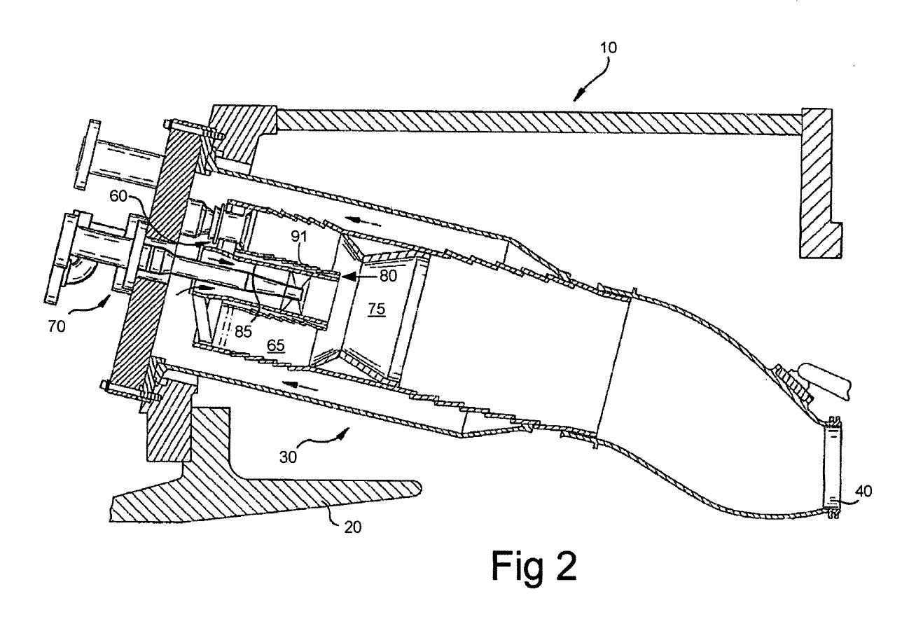

FIG. 2 shows a side cross-sectional view of a known combustor 30. The combustor 30 may be used with a Dry Low NO turbine and the like. The combustor 30 may include a number of primary nozzles 60 surrounding a center secondary nozzle 70. The primary nozzles 60 may be in communication with a primary combustion chamber 65 while the secondary nozzle 70 may be in communication with a secondary combustion chamber 75. Other configurations may be used herein.

As is shown in FIGS. 3 and 4, the secondary nozzle 70 may include an outer swirler 80 positioned about a secondary nozzle wall 85. The outer swirler 80 may include an inner wall 90 positioned about the end of the secondary nozzle wall 85. The outer swirler 80 is further defined by an outer wall 91 and an end wall 92. The end wall 92 may include number of outer blades or vanes 95. These vanes 95 may be angled and provide swirl to the incoming air stream. The swirl helps to stabilize the flame and also helps to improve mixing of the primary fuel-air mixture of primary combustion chamber 65 with the secondary mixture of the secondary combustion chamber 75. Other configurations are known.

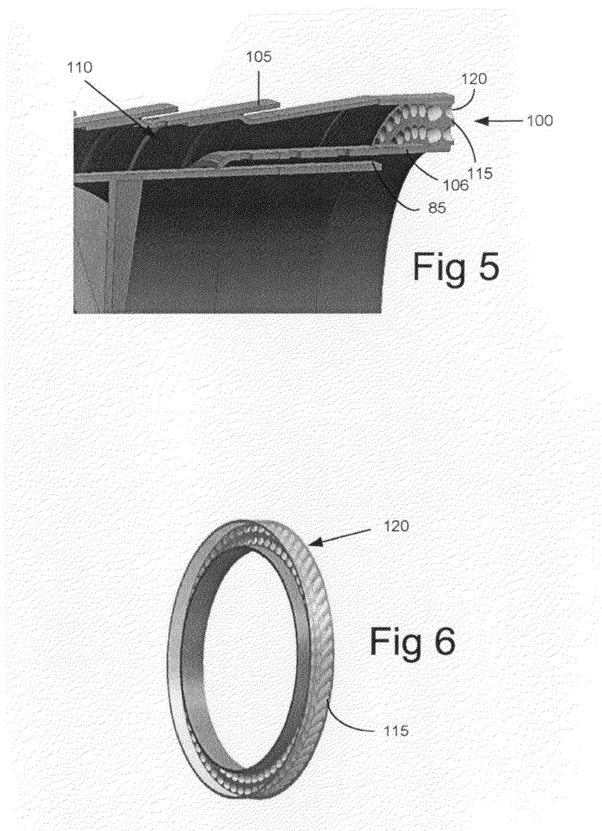

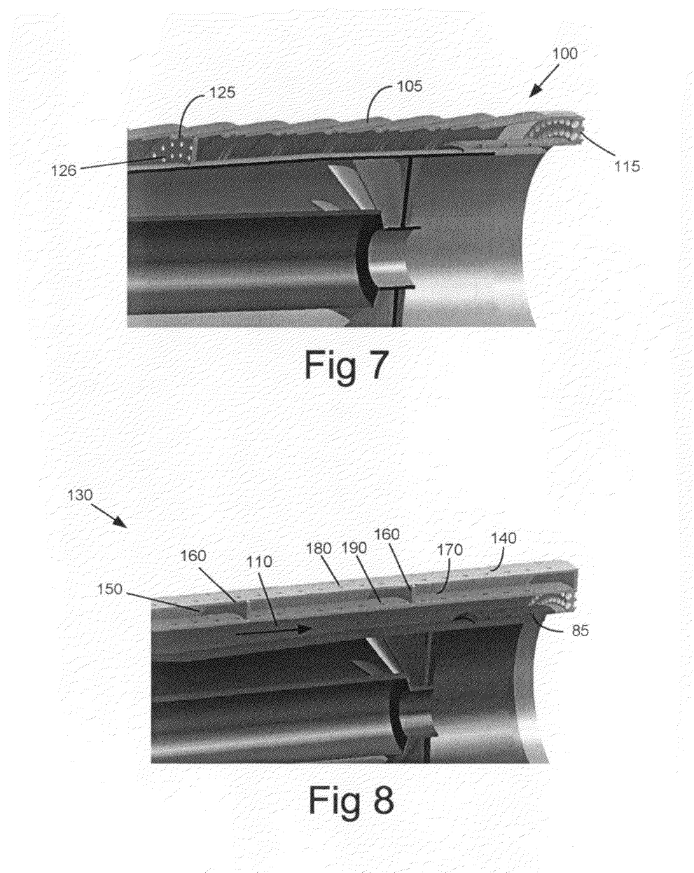

FIGS. 5-7 show an outer swirler 100 as is described herein. The swirler 100 extends from the secondary nozzle wall 85 as described above and includes an outer wall 105 and an inner wall 106. The outer wall 105 defines a cavity or a swirler passage 110 therethrough. The swirler 100 further may include an end wall 115 with a number of apertures 120 extending therethrough. The apertures 120 may be shaped as small round holes. The size and shape of the apertures 120 may vary. Any number of apertures 120 may be used herein. The apertures 120 may be angled within the end wall 116 so as to provide the swirl. The swirler 100 further may include a back end plate 125 with a number of back end plate apertures 126 extending therethrough. The number, length, diameter, shape, and position of the back end plate apertures 126 may vary. The apertures 120, 126 may have different configurations.

The apertures 120 of the swirler 100 thus may act as a type of a Helmholtz resonator. A Helmholtz resonator provides a closed cavity having a sidewall with openings therethrough. The fluid inertia of the gasses within the pattern of the apertures 120 may be reacted by the volumetric stiffness of the swirl passage 110 so as to produce a resonance in the swirl passage 110 that may be an effective mechanism for absorbing acoustic energy. The number, length, diameter, shape, and position of the apertures 120 may vary with respect to the volume of the swirl passage 110. Specifically, the design criteria includes the site of the apertures 120, the diameter of the apertures 120, the number of apertures 120, the mass flow through the swirl passage 110, and the volume of the swirl passage 110. In this example, the apertures 120 may have a diameter of about 0.15 inches (about 3.8 millimeters), a thickness of about 0.65 inches (about 16.5 millimeters), and a flow therethrough of about 2 lbm/sec (about (0.9 kgm/sec) so as to absorb a screech frequency of about 2400 Hz Other dimensions and frequencies may be used herein.

The apertures 120, 126 thus may be designed to absorb one or more frequencies of interest. Specifically, the swirler 100 may be designed for a broad range of frequencies, such as the screech tone around 2400 Hertz and otherwise. The swirler 100 thus provides swirl to the fuel-air flow while mitigating combustion dynamics. Mitigating the combustion dynamics may improve the operability window of the gas turbine engine 10 as a whole. Moreover, the use of a separate resonating device is not needed. Likewise, no modifications may be required for or about the secondary nozzle wall 85.

FIG. 8 shows a further embodiment of a swirler 130 as is described herein. The swirler 130 may include an outer wall 140 that defines an internal cavity or passage 150 along the secondary nozzle wall 85. The passage 150 may include a number of internal baffles 160 and a number of internal plates 170. The outer wall 140 of the swirler 130 also may include a number of outer wall apertures 180 therein. The internal plate 170 of the swirler 130 also may include a number of internal plate apertures 190. Similar to the apertures 120 described above, the size, shape, number, angle, and position of the outer wall apertures 180 and the internal plate apertures 190 may vary according to the desired frequency. The apertures 120 of the end wall 115 of the swirler 100 also may be used herein.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A swirler for a turbine combustor, comprising:
an outer wall;
a passage defined by the outer wall; and
an end wall;
wherein the end wall comprises a plurality of apertures therethrough.

2. The swirler of claim 1, further comprising a resonance frequency therethrough.

3. The swirler of claim 2, wherein the resonance frequency comprises about 2400 Hertz.

4. The swirler of claim 1, wherein the plurality of apertures comprises a plurality of angled apertures.

5. The swirler of claim 1, wherein the outer wall comprises a plurality of outer wall apertures therein.

6. The swirler of claim 1, wherein the passage comprises a plurality of baffles therein.

7. The swirler of claim 1, further comprising a back end plate with a plurality of back end plate apertures.

8. The swirler of claim 1, further comprising an outer swirler of a secondary fuel nozzle.

9. A swirler for a turbine combustor, comprising:
an outer wall;
an inner wall;
a cavity defined by the outer wall and the inner wall; and
an end wall;
wherein the outer wall comprises a plurality of outer wall apertures therethrough.

10. The swirler of claim 9, further comprising a resonance frequency therethrough.

11. The swirler of claim 10, wherein the resonance frequency comprises about 2400 Hertz.

12. The swirler of claim 9, wherein the end wall comprises a plurality of end wall apertures therein.

13. The swirler of claim 9, further comprising an internal plate positioned about the cavity.

14. The swirler of claim 13, wherein the internal plate comprises a plurality of internal plate apertures.

15. The swirler of claim 9, wherein the cavity comprises a plurality of baffles therein.

16. An outer swirler for a secondary nozzle of a turbine combustor, comprising:
an outer wall;
a nozzle wall
a passage defined by the outer wall and the nozzle wall; and
an end wall;
wherein the end wall comprises a plurality of apertures therethrough such that the swirler comprises a resonance frequency therethrough.

17. The swirler of claim 16, wherein the resonance frequency comprises about 2400 Hertz.

18. The swirler of claim 16, wherein the plurality of apertures comprises a plurality of angled apertures.

19. The swirler of claim 16, wherein the outer wall comprises a plurality of outer wall apertures therein.

20. The swirler of claim 16, further comprising a back end plate with a plurality of back end plate apertures.
